(19) United States
(12) Patent Application Publication
(10) Pub. No.: US 2026/0259706 A1
(43) Pub. Date: Sep. 3, 2026

(54) GENERATING CODE FIXES FOR MOBILE SOFTWARE APPLICATION CRASHES USING LARGE LANGUAGE MODELS

(71) Applicant: FMR LLC, Boston, MA (US)

(72) Inventors: Jiadong Shi, Dalian (CN); Shijun Wang, Shanghai (CN); Eoin O'Connor, Boston, MA (US); Jing Sun, Dalian (CN); Zhe Luo, Dalian (CN)

(21) Appl. No.: 19/066,577

(22) Filed: Feb. 28, 2025

(51) Int. Cl. G06F 8/35; G06F 11/362; G06F 11/3668

(52) U.S. Cl. CPC G06F 8/35; G06F 11/366; G06F 11/3688

(57) ABSTRACT

Methods and systems for generating code fixes for mobile software application crashes include a server that detects a crash event for a mobile application by scanning crash logs and determining a code fix template associated with the crash event using a crash fix knowledge base. The server generates source code using an LLM to fix the crash event for the mobile application and executes software tests against the generated source code to validate that the generated source code is executable and passes the software tests. The server integrates the generated source code into existing source code for the mobile application.

### TECHNICAL FIELD

This application relates generally to methods and apparatuses, including computer program products, for generating code fixes for mobile software application crashes using large language models (LLMs).

### BACKGROUND

Mobile computing devices (e.g., smartphones, tablets) have revolutionized the way people carry out their daily lives. There are many different types of mobile computing devices, with different brands and models offering diverse features and specifications. The mobile device market is dynamic, and new types of mobile devices offering improved technical capabilities and software functions routinely emerge over time.

As a result, development and testing of mobile device application software is extremely difficult. It is impossible to test a mobile application (or app) on every available model of mobile devices. Consequently, many organizations choose to test their mobile software applications in a bifurcated fashion: a) test applications on a small number of physical device models that are the most popular and b) use virtual mobile device simulators to test the applications on other models. However, such virtual simulators cannot account for all possible scenarios that may occur on physical mobile devices. As a result, mobile application crashes go undetected during app development and testing, which results in crash events happening to end users. These crash events are almost always unexpected and occur without warning to the end user, resulting in a diminished experience for the end user. This may lead users to give poor reviews to certain applications or even simply cause the user to uninstall a poor-performing mobile application.

To address the above-described problems resulting from mobile application crashes, a number of different application logging systems exist in the market. These logging systems can be configured to log all crash events that occur on a particular mobile device. However, due to the unpredictable nature of app crashes on the end user side, it is difficult for mobile app owners to proactively address the cause(s) for such crashes. In addition, the sheer size of logs generated by these logging systems makes it very time consuming to review and understand the specifics around when a crash event occurred and what element of a mobile application triggered the crash event.

### SUMMARY

The methods and systems described herein beneficially overcome the technical deficiencies noted above to automatically generate code fixes for mobile software application crashes using advanced machine learning technology. The techniques described herein advantageously provide for a curated knowledge base of mobile app exception events and corresponding code fix templates that can be used to identify crash events from mobile app log files, ascertain the particular section or line of code in the mobile application code base that caused the crash event, select a code fix template that ameliorates the crash event, and integrate this information into an input prompt for a large language model (LLM) which automatically generates changes and updates to existing code.

The invention, in one aspect, features a system for generating code fixes for mobile software application crashes using large language models. The system includes a server computing device with a memory for storing computer-executable instructions and a processor that executes the computer-executable instructions. The server computing device detects a crash event for a mobile software application by scanning one or more crash logs, the crash event referencing a code line that triggered the crash event and a crash type. The server computing device determines a code fix template associated with the crash event using a crash fix knowledge base. The server computing device generates, using a large language model (LLM), source code to fix the crash event for the mobile software application by providing the code line that triggered the crash event, the crash type, and the code fix template as input to the LLM. The server computing device executes one or more software tests against the generated source code to validate that the generated source code is executable and passes the one or more software tests. The server computing device integrates the generated source code into existing source code for the mobile software application.

The invention, in another aspect, features a computerized method of generating code fixes for mobile software application crashes using large language models. A server computing device detects a crash event for a mobile software application by scanning one or more crash logs, the crash event referencing a code line that triggered the crash event and a crash type. The server computing device determines a code fix template associated with the crash event using a crash fix knowledge base. The server computing device generates, using a large language model (LLM), source code to fix the crash event for the mobile software application by providing the code line that triggered the crash event, the crash type, and the code fix template as input to the LLM. The server computing device executes one or more software tests against the generated source code to validate that the generated source code is executable and passes the one or more software tests. The server computing device integrates the generated source code into existing source code for the mobile software application.

Any of the above aspects can include one or more of the following features. In some embodiments, the crash fix knowledge base comprises a plurality of mappings each including a code line, a crash type, and a code fix template. In some embodiments, the code fix templates in the crash fix knowledge base are generated based upon proven crash fixes from integrated bug fix systems. In some embodiments, the server computing device determines the crash type and the code fix template associated with the crash event by comparing the code line that triggered the crash event to the plurality of mappings.

In some embodiments, the LLM generates the source code to fix the crash event by modifying the code fix template to incorporate one or more code elements from the code line that triggered the crash event. In some embodiments, when the server computing device determines that the generated source code is not executable, the server computing device generates new source code to fix the crash event by re-submitting the code line that triggered the crash event, the crash type, and the code fix template as input to the LLM. In some embodiments, when the server computing device determines that the generated source code fails one or more of the software tests, the server computing device generates new source code to fix the crash event by re-submitting the code line that triggered the crash event, the crash type, and the code fix template as input to the LLM.

In some embodiments, the server computing device stores the generated source code in a source code repository associated with the mobile software application. In some embodiments, the server computing device integrates the generated source code into existing source code for the mobile software application by merging the generated source code into a branch in the source code repository associated with the mobile software application. In some embodiments, the server computing device recompiles the source code for the mobile software application to generate a new version of the mobile software application that includes the generated source code. In some embodiments, the server computing device distributes the new version of the mobile software application to one or more mobile computing devices.

In some embodiments, the crash type comprises a null pointer exception or an illegal argument exception. In some embodiments, the one or more software tests comprise continuous integration tests.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating code fixes for mobile software application crashes using large language models.

FIG. 2 is a flow diagram of a computerized method of generating code fixes for mobile software application crashes using large language models.

FIG. 3A is a diagram of an exemplary crash log excerpt that comprises a null pointer exception crash event.

FIG. 3B is a diagram of an exemplary crash log excerpt that comprises a number format exception crash event.

FIG. 4 is a workflow diagram of a computerized method for automatically generating exception fix templates for a crash fix knowledge base based upon developer code fixes.

FIG. 5 is a diagram of exemplary LLM input prompt data and corresponding LLM output data for automatically generating a code fix for a null pointer exception crash event that occurred in the mobile software application.

FIG. 6 is a diagram of exemplary LLM input prompt data and corresponding LLM output data for automatically generating a code fix for an illegal argument exception crash event that occurred in the mobile software application.

### DETAILED DESCRIPTION

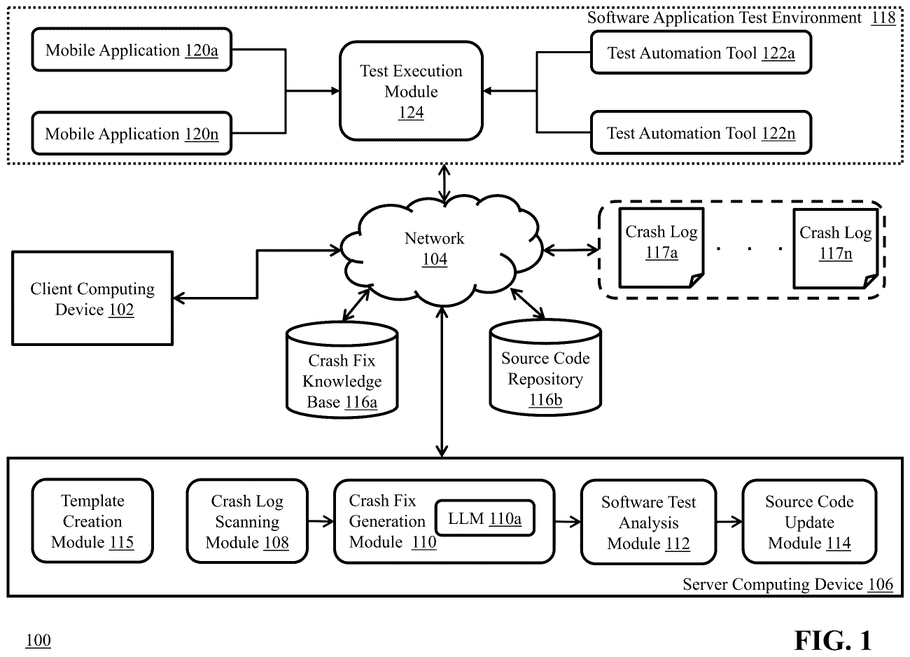

FIG. 1 is a block diagram of a system for generating code fixes for mobile software application crashes using large language models. System 100 includes client computing device 102, communications network 104, server computing device 106 comprising crash log scanning module 108, crash fix generation module 110 with large language model (LLM) 110a, software test analysis module 112, source code update module 114, and template creation module 115, crash fix knowledge base 116a, source code repository 116b, crash logs 117a-117n, and software application test environment 118 including mobile software applications under test 120a-120n, test automation tools 122a-122n, and test execution module 124.

Client computing device 102 uses software and circuitry (e.g., one or more processors and memory modules) to execute applications and communicate with server computing device 106, crash fix knowledge base 116a, source code repository 116b, and/or software application test environment 118 via communications network 104 for the purpose of generating code fixes for mobile software application crashes using large language models. Exemplary client computing devices 102 include but are not limited to desktop computers, laptop computers, tablets, mobile devices, smartphones, and internet appliances. It should be appreciated that other types of computing devices capable of connecting to the components of system of FIG. 1 can be used without departing from the scope of invention. Although FIG. 1 depicts a single client computing device 102, it should be appreciated that system 100 of FIG. 1 can include any number of client computing devices. And as mentioned above, in some embodiments client computing device 102 is coupled to a display (e.g., screen, monitor) for receiving data from server computing device 106, crash fix knowledge base 116a, source code repository 116b, and/or software application test environment 118 and displaying data to a user of client computing device 102.

Communications network 104 enables the other components of system 100 to communicate with each other in order to perform functions relating to the process of generating code fixes for mobile software application crashes using large language models as described herein. Network 104 may be a local network, such as a LAN, or a wide area network, such as the Internet and/or a cellular network. In some embodiments, network 104 is comprised of several discrete networks and/or sub-networks (e.g., cellular to Internet) that enable the components of system 100 of FIG. 1 to communicate with each other.

Server computing device 106 is a computing device (or in some embodiments, a set of computing devices) that comprises a combination of hardware, including one or more processors and one or more physical memory modules, and specialized software modules that execute on processor(s) of server computing device 106, to receive data from other components of system 100, transmit data to other components of system 100, and perform functions for generating code fixes for mobile software application crashes using large language models as described herein. As mentioned above, server computing device 106 includes crash log scanning module 108, crash fix generation module 110 with large language model (LLM) 110a, software test analysis module 112, source code update module 114, and template creation module 115.

In some embodiments, modules 108, 110, 112, 114, and 115 are specialized sets of computer software instructions programmed onto one or more dedicated processors in server computing device 106 and can include designated memory locations and/or registers for executing the specialized computer software instructions. Although modules 108, 110, 112, 114, and 115 are shown in FIG. 1 as executing within the same server computing device 106, in some embodiments the functionality of modules 108, 110, 112, 114, and 115 can be distributed among a plurality of server computing devices. As shown in FIG. 1, server computing device 106 enables modules 108, 110, 112, 114, and 115 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 108, 110, 112, 114, and 115 is described in detail below.

Crash fix knowledge base 116a is a computing device (or in some embodiments, a set of computing devices) that is coupled to server computing device 106 via network 104 and is configured to receive, generate, and store specific data elements relating to the process of generating code fixes for mobile software application crashes using large language models as described herein. In some embodiments, all or a portion of knowledge base 116a can be integrated with server computing device 106 or be located on a separate computing device or devices. For example, knowledge base 116a can comprise one or more databases, file stores, artifact repositories, and other types of functions for storing data/metadata associated with mobile software application crashes and related code fixes. Generally, knowledge base 116a contains a plurality of data structures each comprising (i) a line or snippet of application source code that contains an exception that caused the mobile software application to crash; (ii) a crash type (e.g., an identifier corresponding to the type of crash/exception); and (iii) a code fix template (also called an exception fix template), i.e., a snippet of application source code that contains a fix for the associated exception.

Software application test environment 118 is a computing platform comprising one or more computing devices that provide test automation software tools 122a-122n (e.g., Sahi™, Selenium™) for the execution of software test automation scripts that automatically execute features and functions of mobile software applications 120a-120n that are being tested in environment 118. Test execution module 124 is configured to select a mobile application 120a-120n against which test automation scripts are executed by one or more of the test automation tools 122a-122n. An exemplary software application under test can be a mobile application that is execute on a mobile operating system platform or device (e.g., iOS™, Android™, or other similar platforms), although other types of software applications under test can be contemplated within the scope of invention. In some embodiments, software application test environment 118 is accessible by software installed at the client computing device 102 to enable client computing device 102 to connect to test execution module 124 via an HTTP session in a browser, provide commands for the execution of particular test scripts, and receive application data and test results in response to the commands. Test automation scripts 126a-126n comprise code files written in any of a number of different programming languages (e.g., Java, Python) that are run by test automation tools 122a-122n to automatically carry out functionality in the application under test.

In one embodiment, a user at client computing device 102 issues a command to test execution module 124 of software application test environment 118 for the execution of one or more automation test scripts against, e.g., one or more mobile applications being tested 120a-120n. Test execution module 124 then initializes one or more test automation tools 122a-122n using, e.g., defined configuration parameters based upon the application(s) being tested and executes the test scripts to activate functionality of the mobile applications under test and capture corresponding outcomes and resulting files from execution of the test scripts (e.g., logs, image screenshots of an application user interface (UI), message notifications, error messages, etc.). In some embodiments, software application test environment 118 can transmit files, messages, or other notifications that result from the test execution to server computing device 106 as described herein.

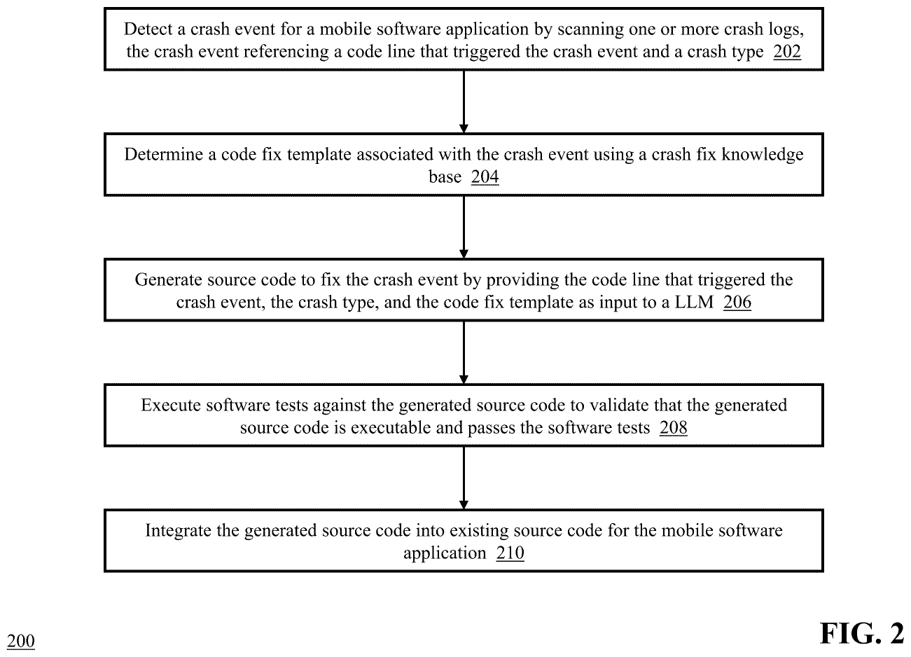

FIG. 2 is a flow diagram of a computerized method 200 of generating code fixes for mobile software application crashes using large language models, using system 100 of FIG. 1. Crash log scanning module 108 of server computing device 106 detects (step 202) a crash event for a mobile software application by scanning one or more crash logs 117a-117n. In some embodiments, crash logs 117a-117n are generated by one or more client computing devices 102 during operation of the mobile software application. For example, a user of client computing device 102 may launch the mobile application and begin using the application functionality. During such use, the mobile application may encounter programmatic errors and/or device errors that can cause the application to unexpectedly terminate or ‘crash.’ When termination occurs, the application user interface can abruptly disappear from the screen of the client computing device. In some cases, the operating system of the client computing device may display an error message to the user indicating that an error has caused the application to crash. In addition, the mobile software application and/or the operating system can create a crash log that records certain data and/or metadata that relate to the crash event. In some embodiments, the crash log is stored locally on the client computing device and/or transmitted to a central repository (e.g., an app store that provides the mobile software application for download) for storage. In some embodiments, each crash event stored in the crash log references a code line (i.e., a specific line number in the mobile application source code or other reference identifier to a specific area of the source code) that triggered the crash event and a crash type. Crash types can include, but are not limited to, null pointer exceptions, illegal argument exceptions, and memory access issues, among others. The crash log can also contain other types of information relating to the crash event, such as timestamp, mobile application identifier, process id, client device characteristics (e.g., operating system version, memory size, carrier/service provider), user identifier, and so forth. Crash log scanning module 108 receives one or more crash logs 117a-117n for the mobile software application from client computing device 102 and/or other remote computing devices (e.g., app store server) and analyzes the crash logs to detect crash events contained in the logs. In some embodiments, module 108 can scan the crash log to identify particular blocks of text in the log that corresponds to a crash event (e.g., by looking for certain text strings or identifiers in the log). As one example, module 108 may be configured to detect the string “bug_type” or “incident” in the crash log and extract certain portions of the crash log that relate to the detected string. In some embodiments, each crash event can be contained in a separate crash log.

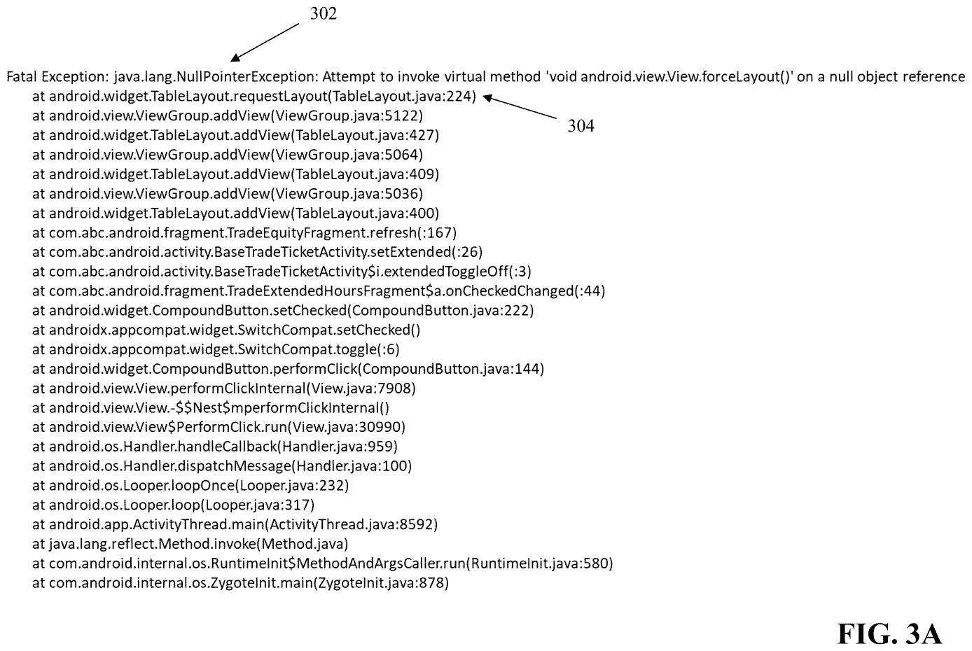

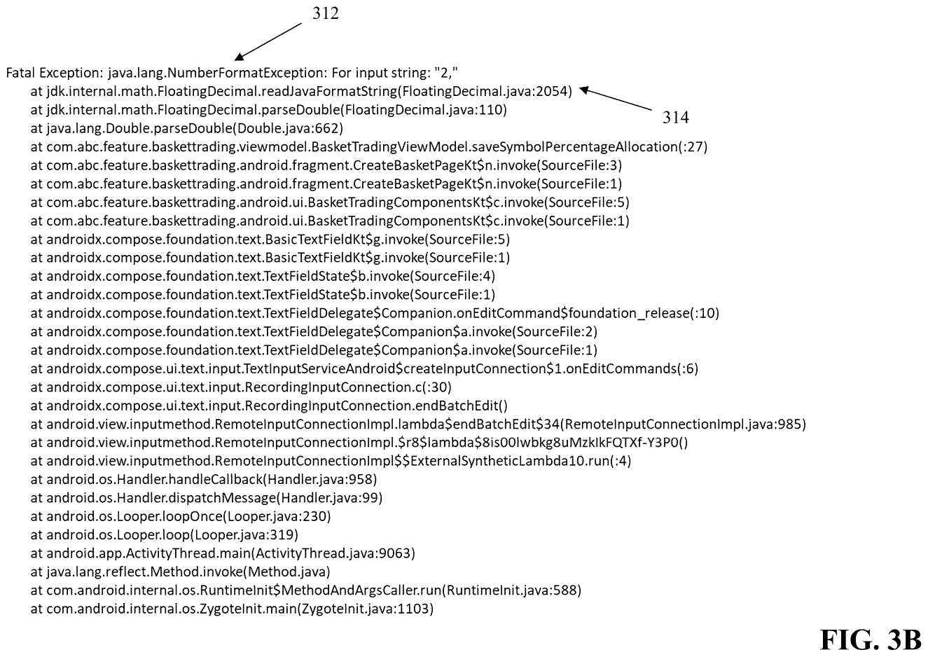

FIG. 3A is a diagram of an exemplary crash log excerpt that comprises a null pointer exception crash event. As shown in FIG. 3A, the crash log comprises a line 302 that identifies the particular type of crash (i.e., NullPointerException) along with a short description of the event. The log also includes entries that indicate the specific code class(es)/method(s)/line(s) in the application where an error occurred that caused the crash event. For example, entry 304 of the log indicates that the error occurred at line 224 of TableLayout.java class, where line 224 includes a call to the android.widget.TableLayout.requestLayout( ) method. FIG. 3B is a diagram of an exemplary crash log excerpt that comprises a number format exception crash event. As shown in FIG. 3B, the crash log comprises a line 312 that identifies the particular type of crash (i.e., NumberFormatException) along with a short description of the event. The log also includes entries that indicate the specific code class(es)/method(s)/line(s) in the application where an error occurred that caused the crash event. For example, entry 314 of the log indicates that the error occurred at line 2054 of FloatingDecimal.java class, where line 2054 includes a call to the jdk.internal.math.FloatingDecimal.readJavaFormatString( ) method.

Upon detecting one or more crash events from the crash logs 117a-117n, crash fix generation module 110 of server computing device 106 determines (step 204) a code fix template associated with the crash event using crash fix knowledge base 116a. As set forth previously, an important feature of the methods and systems is the creation of crash fix knowledge base 116a to enable the process of automated generation of code fixes for mobile software application crashes using large language models described herein. In some embodiments, the data structures contained in knowledge base 116a can be curated by developers of the mobile software application. As crash events are observed, the developers can create code fixes for specific crash events and generate corresponding data structures for inclusion in knowledge base 116a. In some embodiments, server computing device 106 can automatically generate new code fix templates based upon development activity that is captured in source code repository 116b. As can be appreciated, developers of the mobile software application periodically make improvements and changes to the source code of the application, including the application of fixes for various bugs, errors, and exceptions. Typically, developers utilize a source code management platform that is configured to store and manage source code files, components, and other elements of a mobile software application under development in a defined repository (e.g., repository 116b). The source code management platform can include features such as version control, peer code review, change tracking, and branch creation and management. In some embodiments, the source code management platform can be hosted on one or more remote computing devices (e.g., cloud-based architecture) that are accessible to server computing device 106 (e.g., via an application programming interface (API)). Exemplary source code management platforms that can interface with server computing device 106 and source code repository 116b include, but are not limited to, GitHub™ (available at github.com), Bitbucket™ (available from Atlassian, Inc.), and Microsoft® Azure DevOps™ (available from Microsoft Corp.).

In some embodiments, the source code management platform can include an incident ticket and/or issue tracking system that stores and tracks incident data relating to errors or issues with the mobile software application for developer assignment, review and resolution. For example, incident ticket data can comprise information including an incident type, an incident message, an exception type, an application id, a code pointer, a timestamp, and an assigned developer. An exemplary issue tracking system that can be used is JIRA™ from Atlassian, Inc.

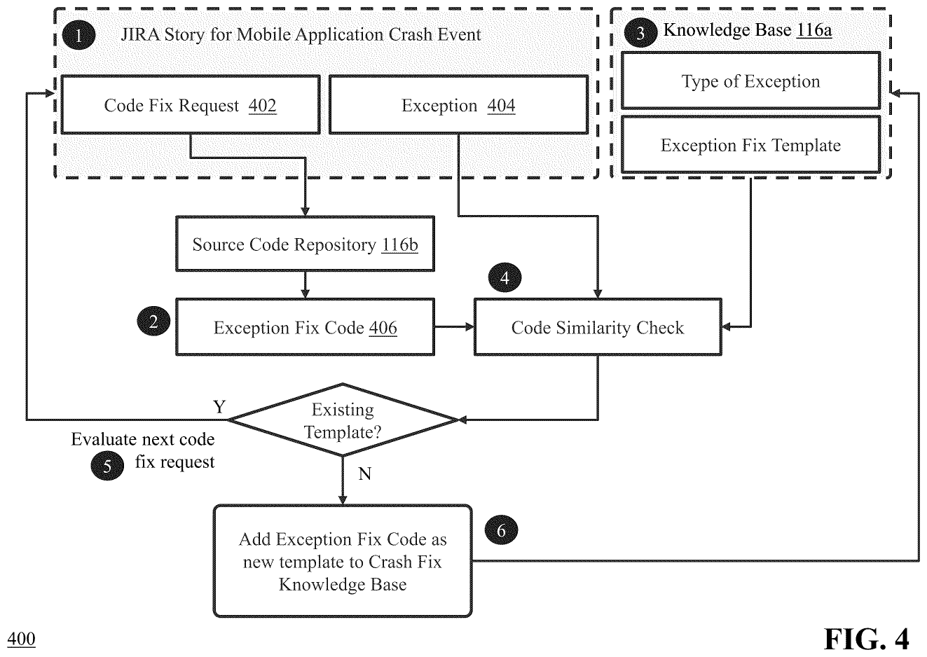

Template creation module 115 is configured to capture information from the source code repository 116b that relates to incident tickets for the mobile software application and automatically generate exception fix templates for new or previously undetected application exceptions, where the newly generated exception fix templates are then integrated into knowledge base 116a. FIG. 4 is a workflow diagram of a method 400 for automatically generating exception fix templates for knowledge base 116a based upon developer code fixes. As shown in FIG. 4, when a crash event occurs for the mobile software application, a developer can create (step 1) a code fix request 402 (e.g., a JIRA story) for the specific crash event in the source code management platform. In some embodiments, the code fix request 402 is mapped to a specific exception 404 (and/or exception type) that was generated by the mobile software application when the crash occurred. The code fix request 402 and exception 404 information are stored in the source code repository 116b to await assignment to a developer who will analyze the exception and write code to fix the exception. Next, an assigned developer generates (step 2) source code to fix the exception identified in the code fix request and checks in the code changes to the source code repository 116b.

Template creation module 115 of server computing device 106 detects that exception fix code has been checked in to source code repository 116b in response to a code fix request 402. For example, the source code management platform can initiate transmission of indicia (e.g., a notification message) to template creation module 115 when a code fix request 402 is marked as ‘resolved’ by a developer. Upon receiving the indicia, template creation module 115 executes a process to determine (i) whether to add the exception fix code 406 to crash fix knowledge base 116a as a new code fix template or (ii) whether the corresponding exception is already addressed by a similar code fix in knowledge base 116a and the new exception fix code does not need to be added to knowledge base 116a.

Template creation module 115 retrieves (step 3) one or more exception fix templates from knowledge base 116a based upon the exception 404 associated with the code fix request 402. In some embodiments, module 115 compares the exception name and/or exception type for the code fix request 302 with the corresponding data in knowledge base 116a to select one or more exception fix templates from knowledge base 116a that have a matching exception name/exception type. It should be appreciated that other methods for identifying and retrieving relevant exception fix templates from knowledge base 116a can be used within the scope of the technology described herein.

Template creation module 115 performs (step 4) a code similarity check between the exception fix code for the code fix request 402 and the one or more exception fix templates retrieved from knowledge base 116a. In some embodiments, module 115 can compare the exception fix code and the templates using an identity match (i.e., to determine whether the exception fix code exactly matches one of the templates). In some embodiments, module 115 can compare the exception fix code 406 and the templates using a similarity measure to generate a metric that represents how similar the exception fix code is to each template. Then, module 115 can identify one of the templates that is the most similar to the exception fix code as a match. In some embodiments, module 115 can utilize a threshold similarity value to determine whether a template should be considered as a match to the exception fix code. For example, when the exception fix code is at least 85% similar to a template, module 115 can identify the template as a candidate match. For templates that are not at least 85% similar to the exception fix code, module 115 can eliminate the templates from further consideration. Then, module 115 can identify the code fix template that has a highest similarity value to the exception fix code as the final match, from the templates that have a similarity measure of at least 85%.

When a code fix template is determined to be a match to the exception fix code, module 115 does not add the exception fix code to knowledge base 116a as a new template because the exception fix code is similar enough to an existing template. This avoid the creation of highly similar and/or duplicate exception fix templates in knowledge base 116a that may introduce an undesirable level of variability in the code fixes being applied to mobile device application. In some embodiments, template creation module 115 then connects to source code management platform to evaluate (step 5) the next code fix request submitted by developers using the same process.

In some embodiments, template creation module 115 can determine that knowledge base 116a does not contain any templates that are considered a match to the exception fix code in the code fix request 402. For example, the exception being addressed by the code fix request 402 may be a new exception type that has not previously occurred in the mobile device application and/or has not previously been detected by developers of the application. In this scenario, knowledge base 116a may not include any exception fix templates that relate to the exception type. Template creation module 115 adds (step 6) the exception fix code from the code fix request 402 as a new fix template in the crash fix knowledge base 116a. Advantageously, by using the workflow process described in FIG. 4, system 100 continually enhances crash fix knowledge base 116a with new code fix templates that resolve different types of exceptions.

Turning back to FIG. 2, crash fix generation module 110 uses the knowledge base 116a to determine a code fix template associated with the crash event using data from crash fix knowledge base 116a. In some embodiments, crash fix generation module 110 compares one or more attributes of the crash event as extracted from the crash log to attributes of each code fix template stored in knowledge base 116a to identify a matching code fix template. For example, a crash event can indicate a specific exception type (e.g., null pointer exception, illegal argument exception) and module 110 can search knowledge base 116a to retrieve a code fix template for an exception type that matches the crash event.

Upon identifying a matching code fix template, crash fix generation module 110 generates (step 206) source code to fix the crash event for the mobile software application using LLM 110a. As described above, module 110 includes LLM 110a which is configured to receive an input prompt generated by module 110. Generally, the input prompt comprises structured or unstructured text that contains that comprises information associated with the crash event and the code fix template—such as identification of the code line that triggered the crash event (including but not limited to the code line and/or code snippet that caused the crash), the crash/exception type, and the code fix template retrieved from knowledge base 116a as input to the LLM 110a. In some embodiments, the input prompt can also include context information (such as natural language instructions) that provides rules and/or guidance for the LLM 110a to follow when generating the output. Upon processing the input prompt, the LLM 110a is configured to generate output that includes source code to fix the exception. In some embodiments, the LLM 110a generates the output source code by modifying and/or updating the input code snippet according to one or more characteristics of the input code fix template. The LLM 110a can comprise an instance of a general-purpose generative artificial intelligence (AI) model that is trained on a large corpus of varying types of information from many different data sources—such as GPT-4 Omni (GPT-4o) from OpenAI, Inc. In some embodiments, the LLM 110a can comprise a more specialized generative AI model that is trained on source-code specific data sources and text—such as Github Copilot™ from Github, Inc. Other LLMs or generative AI frameworks can be used within the scope of technology described herein.

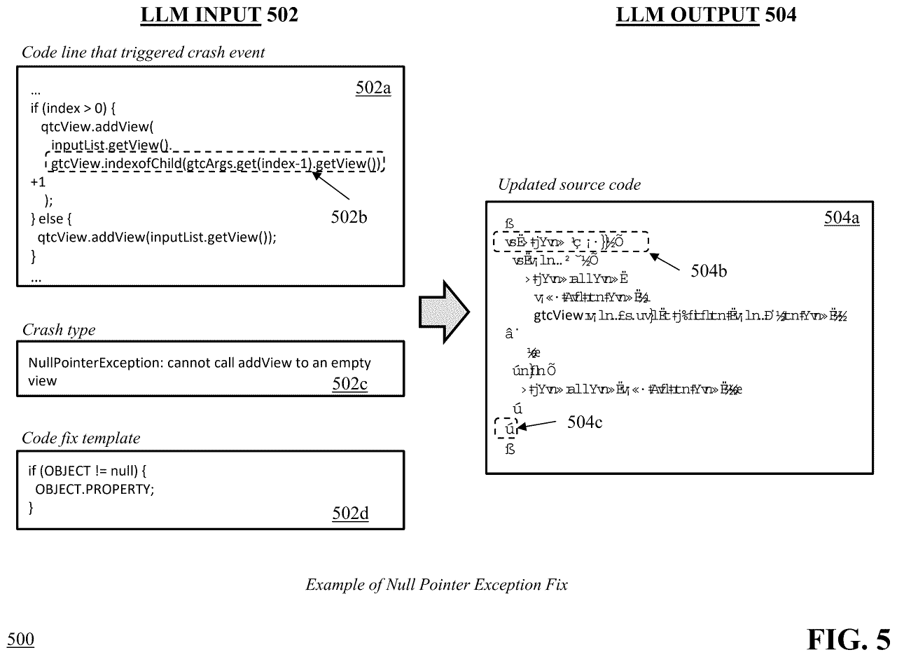

FIG. 5 is a diagram of exemplary LLM input prompt data 502 and corresponding LLM output data 504 for automatically generating a code fix for a null pointer exception crash event that occurred in the mobile software application. As shown in FIG. 5, the input prompt data 502 includes a code snippet 502a from the mobile device application including an identification of the specific code line 502b extracted from the crash logs 117a-117n as being associated with the crash event. The input prompt 502 also includes the crash type 502c (i.e., “NullPointerException”). In this example, the crash type 502c also includes a message from crash logs 117a-117n that provides further information on what caused the exception (“cannot call addView to an empty view”). The input prompt 502 also includes the code fix template 502d stored in knowledge base 116a for this particular crash type. In some embodiments, the input prompt data can be constructed by crash fix generation module 110 to include context information to assist LLM 110a in generating the output code. For example, the input prompt can include an instruction to the LLM 110a that prefaces items 502a, 502c and 502d, i.e., “Based upon the following code snippet, crash type, and code fix template, please update the code snippet to fix the crash type in view of the code fix template.”

LLM 110a receives the input prompt 502 from module 110 and processes the input prompt to generate updated source code 504a as output 504. As shown in FIG. 5, the output code 504a includes two new lines 404b and 504c inserted into the input code snippet 502a. The lines 504b and 504c embody the code structure provided in code fix template 502d. Specifically, the LLM 110a has a) identified the view object name (qtcView) in line 502b of code snippet 502a which triggered the null pointer exception, b) added an ‘if’ statement (line 504b) at the beginning of the input code snippet to check whether the qtcView object is not null (which syntactically aligns with the first line of the code fix template 502d), and c) added a close bracket at the end of the input code snippet (line 504c) that is required by the inserted ‘if’ statement (aligning with the last line of the code fix template 502d).

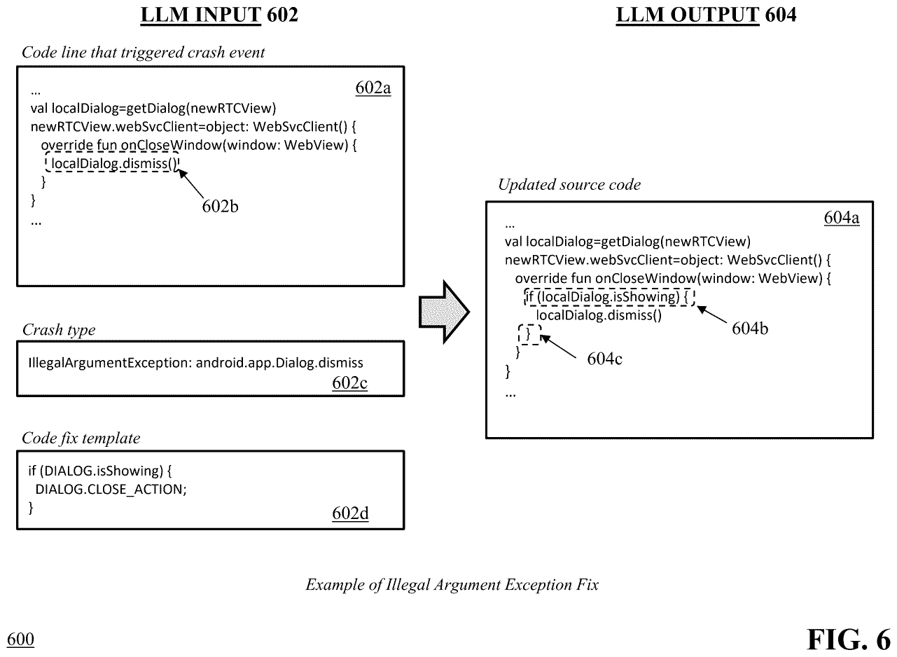

Similarly, FIG. 6 is a diagram of exemplary LLM input prompt data 602 and corresponding LLM output data 604 for automatically generating a code fix for an illegal argument exception crash event that occurred in the mobile software application. As shown in FIG. 6, the input prompt data 602 includes a code snippet 602a from the mobile device application including an identification of the specific code line 602b extracted from the crash logs 117a-117n as being associated with the crash event. The input prompt 602 also includes the crash type 602c (i.e., “IllegalArgumentException”). In this example, the crash type 602c also includes a message from crash logs 117a-117n that provides further information on what caused the exception (“android. app. Dialog. dismiss”). The input prompt 602 also includes the code fix template 602d stored in knowledge base 116a for this particular crash type.

LLM 110a receives the input prompt 602 from module 110 and processes the input prompt to generate updated source code 604a as output 604. As shown in FIG. 6, the output code 504a includes two new lines 604b and 604c inserted into the input code snippet 602a. The lines 604b and 604c embody the code structure provided in code fix template 602d. Specifically, the LLM 110a has a) identified the dialog object name (localDialog) in line 602b of code snippet 602a which triggered the illegal argument exception by calling the dismiss( ) method, b) added an ‘if’ statement (line 604b) at the beginning of the input code snippet to check whether the localDialog object is showing (which syntactically aligns with the first line of the code fix template 602d), and c) added a close bracket at the end of the input code snippet (line 604c) that is required by the inserted ‘if’ statement (aligning with the last line of the code fix template 602d). Crash fix generation module 110 can capture the output source code generated by LLM 110a and store the output source code in, e.g., source code repository 116b.

Turning back to FIG. 2, crash fix generation module 110 can notify software test analysis module 112 that a source code update generated by LLM 110a has been stored in repository 116b. Software test analysis module 112 executes (step 208) one or more software tests against the generated source code to validate that the generated source code is executable and passes the one or more software tests. In some embodiments, module 112 executes the software tests against the source code generated by LLM 110a prior to integrating the source code into the existing mobile software application code base. For example, module 112 can generate a test code branch of the mobile software application code that is separate from a main production code branch in repository 116b. Software test analysis module 112 then locates the source code in the test code branch that corresponds to the source code snippet provided as input to the LLM 110a. Module 110 can check out the relevant source code file(s) from the test code branch, replace the source code snippet in the test code branch with the output source code generated by LLM 110a, and check in the changed source code file(s) to the test code branch—resulting in an automatic update to the mobile software application source code in the test code branch that fixes the exception detected in the crash logs 117a-117n.

Software test analysis module 112 can then generate a test build of the mobile software application from the test code branch and deploy the test build to, e.g., software application test environment 118. As shown in FIG. 1, software test analysis module 112 can deploy the test build as a mobile application 120a-120n running on one or more computing devices in test environment 118. Software test analysis module 112 instructs test execution module 124 to invoke one or more test automation tools 122a-122n against the test build 120a to determine whether the changed source code is successfully integrated with the overall code base. In some embodiments, test execution module 124 determines whether the changed source code is executable. In some embodiments, test execution module 124 performs one or more continuous integration (CI) software tests on the test build to determine whether the test build is operational over a wide range of scenarios and use cases. During the testing process, test execution module 124 can transmit notifications to client computing device 102 and/or server computing device 106 relating to the outcome of testing. For example, if test execution module 124 determines that the changed source code is not executable and/or generates test errors when executed, module 124 can transmit a message to client computing device 102 for developer review. In another example, upon detecting problems with one or more of the software tests, module 124 can inform software test analysis module 112—which instructs crash fix generation module 110 to re-execute the LLM 110a (using the same input prompt or a new input prompt) for creating another output source code snippet that can be tested.

If no issues are detected during the testing phase, source code update module 114 integrates (step 212) the source code generated by LLM 110a into the existing source code base for the mobile software application. In some embodiments, module 114 locates the source code in the test code branch that corresponds to the source code snippet provided as input to the LLM 110a. Module 114 can check out the relevant source code file(s) from repository 116b, replace the source code snippet in repository 116b with the output source code generated by LLM 110a, and check in the changed source code file(s) to repository 116b—resulting in an automatic update to the mobile software application source code that fixes the exception detected in the crash logs 117a-117n. It should be appreciated that integration of the generated source code into the code base of the mobile software application can occur before or after the testing process described above. In some embodiments, upon successful completion of the testing phase, module 114 can create a pull request for the source code management platform to integrate the changed source code into the mobile application code base. Once the pull request is processed, a developer can optionally review the code changes to ensure consistency in form and structure with the rest of the code base.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for generating code fixes for mobile software application crashes using large language models, the system comprising a server computing device with a memory for storing computer-executable instructions and a processor that executes the computer-executable instructions to:
detect a crash event for a mobile software application by scanning one or more crash logs, the crash event referencing a code line that triggered the crash event and a crash type;
determine a code fix template associated with the crash event using a crash fix knowledge base;
generate, using a large language model (LLM), source code to fix the crash event for the mobile software application by providing the code line that triggered the crash event, the crash type, and the code fix template as input to the LLM;
execute one or more software tests against the generated source code to validate that the generated source code is executable and passes the one or more software tests; and
integrate the generated source code into existing source code for the mobile software application.

2. The system of claim 1, wherein the crash fix knowledge base comprises a plurality of mappings each including a code line, a crash type, and a code fix template.

3. The system of claim 2, wherein the code fix templates in the crash fix knowledge base are generated based upon proven crash fixes from integrated bug fix systems.

4. The system of claim 2, wherein the server computing device determines the crash type and the code fix template associated with the crash event by comparing the code line that triggered the crash event to the plurality of mappings.

5. The system of claim 1, wherein the LLM generates the source code to fix the crash event by modifying the code fix template to incorporate one or more code elements from the code line that triggered the crash event.

6. The system of claim 1, wherein when the server computing device determines that the generated source code is not executable, the server computing device generates new source code to fix the crash event by re-submitting the code line that triggered the crash event, the crash type, and the code fix template as input to the LLM.

7. The system of claim 1, wherein when the server computing device determines that the generated source code fails one or more of the software tests, the server computing device generates new source code to fix the crash event by re-submitting the code line that triggered the crash event, the crash type, and the code fix template as input to the LLM.

8. The system of claim 1, wherein the server computing device stores the generated source code in a source code repository associated with the mobile software application.

9. The system of claim 8, wherein the server computing device integrates the generated source code into existing source code for the mobile software application by merging the generated source code into a branch in the source code repository associated with the mobile software application.

10. The system of claim 9, wherein the server computing device recompiles the source code for the mobile software application to generate a new version of the mobile software application that includes the generated source code.

11. The system of claim 10, wherein the server computing device distributes the new version of the mobile software application to one or more mobile computing devices.

12. The system of claim 1, wherein the crash type comprises a null pointer exception or an illegal argument exception.

13. The system of claim 1, wherein the one or more software tests comprise continuous integration tests.

14. A computerized method of generating code fixes for mobile software application crashes using large language models, the method comprising:
detecting, by a server computing device, a crash event for a mobile software application by scanning one or more crash logs, the crash event referencing a code line that triggered the crash event and a crash type;
determining, by the server computing device, a code fix template associated with the crash event using a crash fix knowledge base;
generating, by the server computing device using a large language model (LLM), source code to fix the crash event for the mobile software application by providing the code line that triggered the crash event, the crash type, and the code fix template as input to the LLM;
executing, by the server computing device, one or more software tests against the generated source code to validate that the generated source code is executable and passes the one or more software tests; and
integrating, by the server computing device, the generated source code into existing source code for the mobile software application.

15. The method of claim 14, wherein the crash fix knowledge base comprises a plurality of mappings each including a code line, a crash type, and a code fix template.

16. The system of claim 15, wherein the code fix templates in the crash fix knowledge base are generated based upon proven crash fixes from integrated bug fix systems.

17. The method of claim 15, further comprising determining, by the server computing device, the crash type and the code fix template associated with the crash event by comparing the code line that triggered the crash event to the plurality of mappings.

18. The method of claim 14, further comprising generating, by the LLM, the source code to fix the crash event by modifying the code fix template to incorporate one or more code elements from the code line that triggered the crash event.

19. The method of claim 14, wherein when the server computing device determines that the generated source code is not executable, further comprising generating, by the server computing device, new source code to fix the crash event by re-submitting the code line that triggered the crash event, the crash type, and the code fix template as input to the LLM.

20. The method of claim 14, wherein when the server computing device determines that the generated source code fails one or more of the software tests, further comprising generating, by the server computing device, new source code to fix the crash event by re-submitting the code line that triggered the crash event, the crash type, and the code fix template as input to the LLM.

21. The method of claim 14, further comprising storing, by the server computing device, the generated source code in a source code repository associated with the mobile software application.

22. The method of claim 21, wherein integrating the generated source code into existing source code for the mobile software application comprises merging the generated source code into a branch in the source code repository associated with the mobile software application.

23. The method of claim 22, further comprising recompiling, by the server computing device, the source code for the mobile software application to generate a new version of the mobile software application that includes the generated source code.

24. The method of claim 23, further comprising distributing, by the server computing device, the new version of the mobile software application to one or more mobile computing devices.

25. The method of claim 14, wherein the crash type comprises a null pointer exception or an illegal argument exception.

26. The method of claim 14, wherein the one or more software tests comprise continuous integration tests.
